(19) United States
(12) Patent Application Publication
(10) Pub. No.: US 2016/0057223 A1
(43) Pub. Date: Feb. 25, 2016

(54) METHOD FOR PROCESSING DATA OF A SOCIAL NETWORK USER

(71) Applicant: ORANGE, Paris (FR)

(72) Inventors: Michel Puharre, Chatillon (FR); Carlos Perez, Paris (FR)

(21) Appl. No.: 14/781,124

(22) PCT Filed: Mar. 26, 2014
(86) PCT No.: PCT/FR2014/050704

§ 371 Date: Sep. 29, 2015

(30) Foreign Application Priority Data
Mar. 29, 2013 (FR) 13 52947

(51) Int. Cl. H04L 29/08; H04W 84/18

(52) U.S. Cl. CPC H04L 67/1097; H04L 67/306; H04W 84/18

(57) ABSTRACT

Method for processing user data to be displayed on an internet page of a social network. The user data is stored in a first communicating device and can be consulted remotely by a second communicating device. A server hosts the social network, which is organized according to a mesh network comprising the communicating devices. The server stores an IP address of the first device on a communication network being used by the first device. Upon the request of the second device, the method includes the following steps: the server verifies a relationship between the communicating devices; and, if need be, the server transmits the IP address of the first device to the second device, for direct access to the user data in the first device, using the transmitted IP address.

The present invention relates to the processing of data of a social network user in the field of telecommunications, and more particularly to a method for the management of user data intended for display on a web page of the social network.

“Social network” here refers to a relationship networking platform available to users of a communication network such as an internet. Through this platform, users can be connected by a social relation defined in a relationship networking structure of the social network.

A relationship networking structure may take the specific form (but not exclusively) of a mesh network such as a tree graph where the nodes represent users. Users are linked in the graph of nodes if a social relation has been created or defined between specific users. These social relations can be established and managed by the user or by the administrator of the social network.

A social network is usually hosted on one or more computer entities, such as a server. This server stores and manages the nodes in the tree graph of the social network. In addition, it stores the user data placed online by each of the users of the social network. The users upload their data to the social network server so the data can be displayed on the web page of the social network. Thus, users with a social relation in the graph of nodes can access and display the user data for users they know, via the server of the social network.

However, it has currently been observed that when a user wants to unsubscribe from a social network, for example by deleting his or her account and personal data, user data may still remain at least partially visible and accessible from the social network or viewable from other internet sources. Also, it is understood that there are security issues concerning user data stored on the computer entities of social networks.

In addition, the confidentiality of published data may be compromised through intrusion attacks against social network servers, which could gain access to the user data stored there. Dishonest administrators of social networks could distribute and sell user data stored on their servers to third parties, such as user addresses and telephone numbers for example.

The present invention improves the situation.

For this purpose, it relates to a method for processing user data intended for display on a web page of a social network, wherein:
said user data is stored in a first communicating device and can be viewed remotely by at least a second communicating device,
the social network is organized in a mesh network having a plurality of nodes, and a server hosting the social network associates each node of the mesh network with a communicating device identifier, a first and a second identifier respectively associated with the first and second devices being stored on said server, and
the server stores, in addition to the identifier of the first device, an IP address of the first device on a communication network currently being used by the first device.

Advantageously, the method then comprises, when the second device requests access to the user data, at least the steps of:
verification by the server that the mesh network comprises a relation between the nodes respectively corresponding to the first and second identifiers;
and, when appropriate, transmission of the IP address of the first device to the second device by the server, to allow direct access to said user data on the first device and using the IP address transmitted.

Thus, the invention enables a social network user to maintain local control of his or her user data and provides that:
the user data are stored and managed locally on a communicating device of the user;
the mesh network of the social network remains managed and stored by a computer entity of the social network, such as said server;
but the user data are no longer accessible when the communicating device is not connected and online, or when the user has deleted these user data from the communicating device.

In one embodiment, said server also knows the first device by a unique identifier specific to the first device, a current IP address of the first device being associated with this unique identifier.

Such an embodiment ensures a one-to-one correspondence between the node of the social network and the unique identifier of the device, as the IP address of the device can change in certain cases, but a current IP address remains permanently assigned to the unique identifier. Thus, there is no introduced ambiguity to alter the relation created between the node representing the user in the social network structure and the communicating device of the user (represented by its unique identifier).

For example, the unique identifier specific to the first device may be an identifier of a security element of the first communicating device, usually intended to be used for authentication of said first device.

In another embodiment, a unique identifier is also associated with the second device. Again, there is a one-to-one correspondence between the unique identifier of the second device and the corresponding node in the social network. This unique identifier may again be an identifier of a security element, similarly to the first device.

In one embodiment, the server polls the first device in order to:
determine whether the first device is connected and online,
and, when appropriate, obtain a current IP address of the first device to be associated with said unique identifier.

Thus, the user data are no longer accessible when the communicating device is not connected and/or online, or if the user has removed his or her data from the communicating device. One can see that it is possible for the user to have strict control of the dissemination of data, by implementing the invention.

In one embodiment, the method may further comprise a step of verifying said unique identifier of the first device when there is a request for access to the data stored on the first device, which thus increases the security of the access to user data.

In another embodiment, the method may also comprise a step of verifying the unique identifier of said second device when the request for access to the data stored on the first device is issued.

In one embodiment, the server polls the first device to determine whether the first device is connected and online, and publishes a message of non-availability of the first device, at least in the case of non-availability of data on the first device. In such an embodiment, the communicating device requesting the data is nevertheless informed that it is not possible to access the data, temporarily for example.

Advantageously, in an embodiment where the first device comprises a battery power source, a charge level of the battery is obtained and compared with a threshold and, if the level is below the threshold, the server receives information indicating non-availability of the first device and publishes a message of non-availability of the first device.

In one possible embodiment, the server can periodically poll the first device to obtain the battery charge level, and receives information indicating non-availability of the first device as soon as its battery level is below the threshold. A message of non-availability of the first device is then issued to the communicating devices requesting user data of the first user. Such an embodiment allows, for example, not expending power resources for this application when they are low, or avoiding the risk of an interruption in the data stream if the first device loses power.

Additionally or alternatively, the first device having said battery power source can check the battery charge level, compare it to said threshold, and if the level is below the threshold, inform the server via the non-availability information, so that it no longer receives requests for its user data. A message of non-availability of the first device can be sent by the server to a communicating device requesting user data from the first device. Such an embodiment allows, for example, limiting the power consumption inherent to communicating user data to requesting devices. Thus, the first user can limit power consumption when a minimum charge level is reached, enabling the user for example to maintain enough charge to make an emergency call.

In one embodiment, at least some of the user data are stored by the server so that, in case of non-availability of the first device, they are accessible for viewing by the second device upon request. These are typically public data of the user, mostly impersonal, provided to avoid returning a simple error message for example to a device that cannot access said first device.

In one embodiment, at least some of the user data are only accessible from the first device and comprise personal data including at least:
bank account data,
and/or vital statistics,
and/or personal videos and/or audio data and/or images.

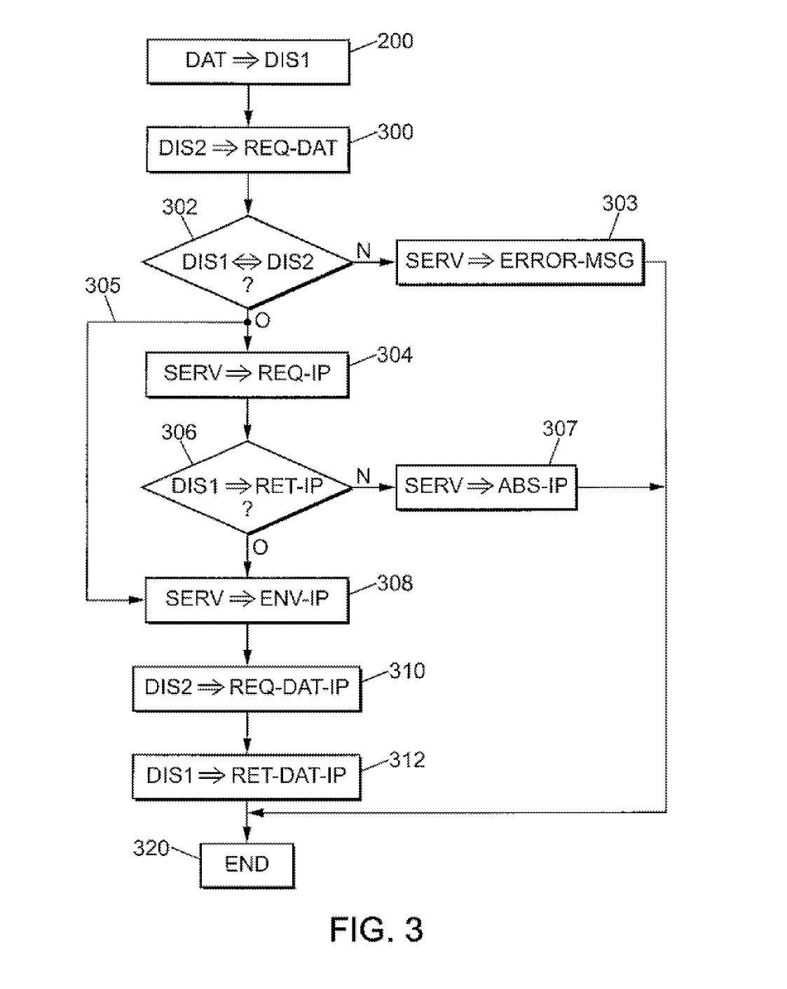

The above method is implemented by computer means, for example using a computer program deployed on the social network server and on said first device. Thus, the invention also concerns such a computer program comprising instructions for implementing the above method when the program is executed by a processor. It is therefore understood that an exemplary flow diagram of the general algorithm of this computer program can be illustrated by way of example by FIGS. 3 and/or 4.

The invention also relates to a communicating device, serving as the first device of the above method, comprising at least means for storing user data, means for communicating an IP address at the request of a social network server, and means for transmitting user data to that IP address at the request of a second communicating device.

The invention also relates to the social network server for implementing the method and thus comprising means:
for associating at least one identifier of a first communicating device with an IP address of the first device,
for storing:
   the first identifier and a second identifier respectively associated with the first device and a second device, and
   an IP address of the first device on a communication network currently being used by the first device,
and:
   for verification by the server that the mesh network comprises a relation between the nodes respectively corresponding to the first and second identifiers;
   and, when appropriate, for transmission of the IP address of the first device to the second device by the server, to allow direct access to said user data on the first device and using the IP address transmitted.

Other features and advantages of the invention will become apparent from reading the following detailed description of some exemplary embodiments presented by way of illustration but in no way limiting, and with reference to the accompanying drawings in which:

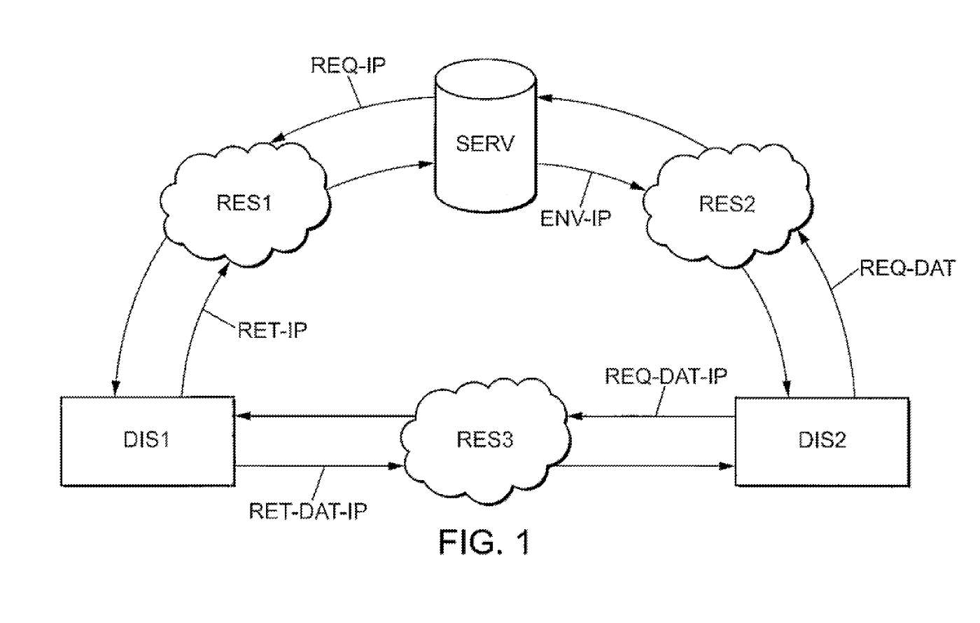

FIG. 1 illustrates an exemplary embodiment of a system making use of said first and second communicating devices, as well as the social network server, these various elements being connected by one or more networks;

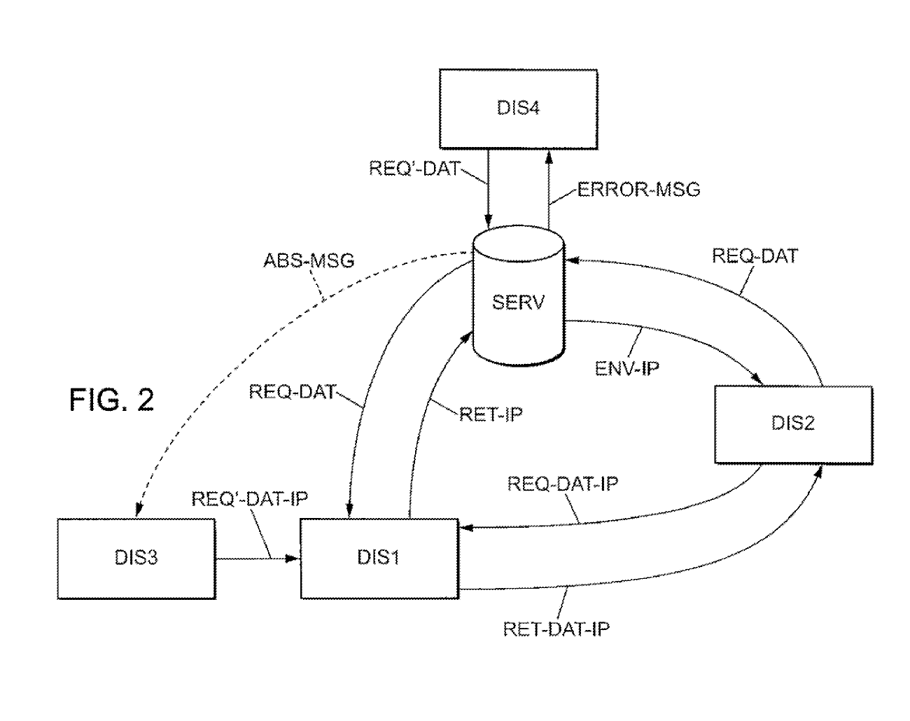

FIG. 2 illustrates an embodiment similar to FIG. 1, but in which other devices are attempting to obtain data from the first device;

FIG. 3 illustrates an embodiment of the method according to the invention, in flowchart form;

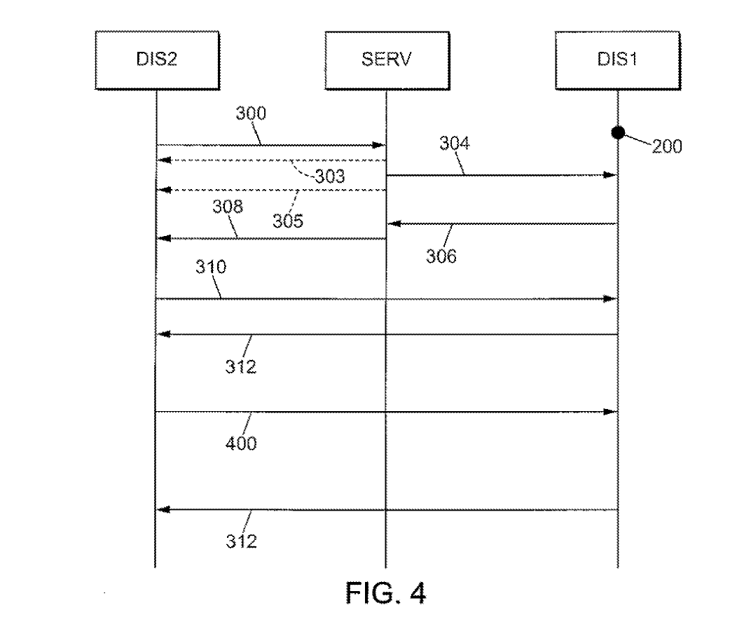

FIG. 4 is a sequence diagram for the method according to FIG. 3;

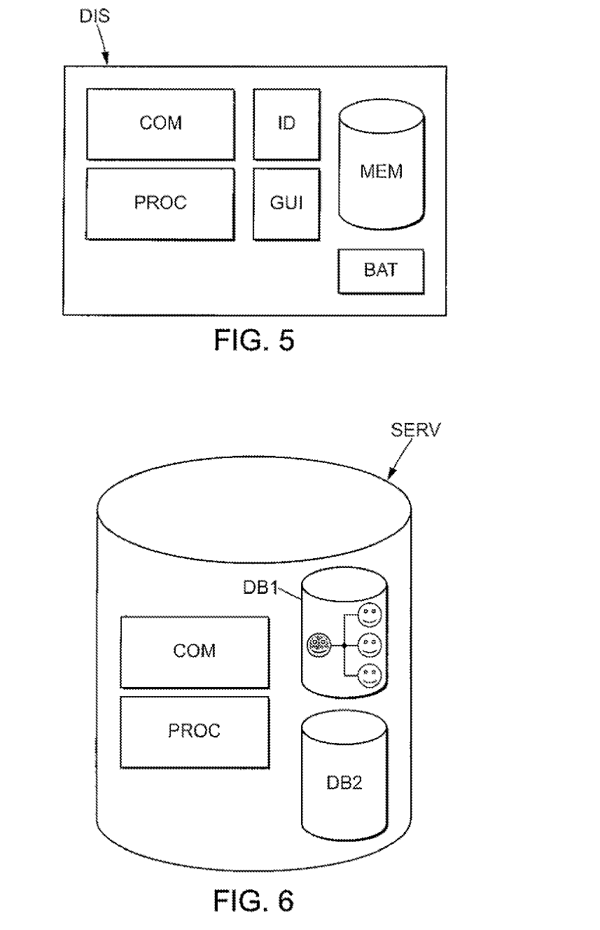

FIG. 5 schematically illustrates a communicating device for implementing the invention;

FIG. 6 schematically illustrates a server for implementing the invention.

In the figures, identical references correspond to identical elements.

FIG. 1 illustrates the case of direct transmission of data from a first user of a first communicating device DIS1, available to this first user, to a communicating device DIS2 available to a second user. Said communicating devices may be mobile phones, smartphones, digital tablets, computers, or any other electronic equipment connected to a network.

For this implementation, the embodiment shown in FIG. 1 includes:
the first and second communicating devices DIS1 and DIS2, each of the two devices being respectively associated with a first identifier ID1 and second identifier ID2,
a server SERV, as the computer entity managing the storage and exchange of user data of the social network, and
one or more communication networks RES1, RES2, RES3, between these elements DIS1, DIS2, SERV.

The networks RES1, RES2, RES3 may be wide-area networks such as the Internet, based on wired and/or wireless communication technology known to the skilled person.

The communicating device DIS2 requests from the server SERV data concerning the user of the communicating device DIS1, in a message REQ-DAT. The message REQ-DAT may contain the respective identifiers ID1 and ID2 for the requesting device DIS2 and the requested device DIS1. These data may have been previously stored by the first user and may be, for example:
personal data such as user profile, identity data, publications on the web page of the social network, or other;
multimedia data such as audio, photos, videos, or other;
location data;
or other.

For the purposes of the invention, the data of the first user are initially stored in the memory of the first communicating device DIS1. Additionally or alternatively, the first user may choose to store some or all of his/her user data locally on the communicating device, and to store the other data on some other communicating equipment he or she owns or is managed by a trusted third party (such as electronic storage space provided to the user by a telecommunications carrier, for example). According to another alternative, the user may also choose to store some or all of his or her user data on other communicating devices and/or on a remote computer entity.

In one possible embodiment, the user may choose to provide access to only a portion of his or her user data stored locally on the communicating device.

When appropriate, the communicating device advantageously comprises a means for controlling access to the data such as a firewall limiting the access of social network users, and/or the access of any other communicating device attempting to access the data stored on the first device, to only the data intentionally made accessible by the user of the device. The first user can thus be assured that other social network users will not have access to other data stored on the communicating device. In addition, the risk of others gaining access to confidential data stored on the device, for example via intrusion attacks from communicating devices, is then limited.

At least some user data may be stored by the server SERV so that, in case of non-availability of the first device, such data are accessible when requested by the second device. These data can, for example, be minimal user profile information or an away message or data identifying the user so that a potential contact can then send a friend request.

The server SERV uses an internal database to determine whether, in the tree of relations concerning the social network, the respective users of the first and second communicating devices are indeed connected via a segment of the tree (possibly traversing one or more intermediate nodes).

For this purpose, the tree of relations is organized in a mesh network having a plurality of nodes. The server SERV, which hosts the social network, associates a communicating device identifier with each mesh network node. Thus, a first identifier ID1 and a second identifier ID2 respectively associated with the first and second devices, mentioned above, are stored in the internal database of the server SERV. In another embodiment, these identifiers may be unique identifiers, such as those associated with a security module or element such as a SIM card. This identifier can be a phone number or the IMSI (International Mobile Subscriber Identity).

The server also accesses said database to obtain contact information for the device DIS1 of the first user. The server SERV is thus able to send a request to the first device DIS1 to obtain the current address of the first device DIS1 on the network RES3 that connects the first and second communicating devices DIS1 and DIS2 (message REQ-IP of FIG. 1). This may be, for example, an IP (Internet Protocol) address, in particular if the network RES3 is a wide area network such as the Internet. On receiving this message REQ-IP, the first device DIS1 returns its IP address in message RET-IP. The server SERV is then able to transmit this IP address to the second device DIS2 (message ENV-IP).

In addition, the server may store, in the identifier of the first device DIS1 in the tree of relations concerning the social network, the address of the first device DIS1 on the communication network currently being used by the first device.

Upon receipt of the IP address of the first device DIS1, the second device DIS2 is now able to request the user data directly from device DIS1 (message REQ-DAT-IP).

The first communicating device DIS1 is able to respond to the direct request of the second communicating device DIS2 (message REQ-DAT-IP), by sending it the data of the first user (message RET-DAT-IP).

The social network user thus retains local control of his or her user data of the social network and these data are no longer accessible when the communicating device is not connected and online, or when the user has deleted the user data from the communicating device.

In addition, it is understood that the user of the first device can make his or her user data inaccessible by unsubscribing from the social network (deletion of the user from the node graph of the social network), in which case the data which remain stored locally on the device are no longer reachable by other users and by the server.

In FIG. 2, examples have been added to FIG. 1 of situations where:
a user of a third-party communicating device DIS4 has no segment connecting him or her to the first user in the social network; Here, the request for user data sent to the server SERV (REQ′-DAT) will be rejected, for example by returning an error message ERROR-MSG;
a communicating device DIS3 has received the IP address of the first device DIS1 but the first device DIS1 is no longer accessible via the network RES3 (device is off, not connected, or other); in this case, the communicating device DIS3 receives no response from the first communicating device DIS1, and after a period of time, obtains from the server SERV information indicating non-availability of the first communicating device DIS1 (message ABS-MSG), or possibly and when appropriate a new IP address of the communicating device DIS1.

Here we will point out that the normal IP address of a computer connected to a switched network is often fixed, while that of a mobile device (traveling for example from one cellular network to another) may in some cases have a dynamic IP address. The server SERV can therefore implement an address translation technique, for example NAT (“Network Address Translation”), to communicate regularly a valid IP address to devices requesting it. In this manner, the IP address of the first device DIS1, which is private between the server SERV and the device DIS1, would be made visible by the server SERV to requesting devices.

In addition, a method may be provided for encrypting the data exchanged between the devices, in order to protect the user data communicated between the communicating devices from any breach of confidentiality in the intermediate computer entities.

In one possible embodiment, the first device DIS1, before sending its user data to a device requesting them, can make a request to the server SERV to identify the requesting device and verify that a relation segment exists between the two devices in the social network. Thus, the user can verify the people wanting to view his or her data and can control access to the data in a secure manner.

The server SERV may also know the first device by means of a unique identifier specific to the first device, an IP address of the first device being associated with this unique identifier. The IP address can be, for example, the current IP address of the first device on the network to which it is connected or, as detailed below, a fixed IP address managed by the server SERV. This unique identifier may be a mobile identifier provided by a security element, for example a telephone SIM card, or may be any type of virtual identifier. In the case of a unique identifier from a SIM card, the server SERV can use an authentication protocol such as EAP-SIM. This identity can be verified at each connection to the first device or at each communication from it.

Such an embodiment ensures a one-to-one correspondence between the communicating device and the unique identifier of the device, as the IP address of the device can change in certain cases, but the current IP address remains permanently assigned to the unique identifier.

In a further embodiment, the server SERV may also know any other device, such as the second device DIS2, by means of a unique identifier specific to said any other device. This unique identifier may be a mobile identifier provided by a security element, for example a telephone SIM card, or may be any type of virtual identifier. In the case of a unique identifier from a SIM card, the server SERV can use an authentication protocol such as EAP-SIM. This identity can be verified at each connection of the second communication device or at each communication from said device, for example when emitting the request REQ-DAT described below.

Such an embodiment ensures a one-to-one correspondence between any communicating device and the unique identifier of the device in the social network. Each node of the network is in fact associated with an identifier of the mobile device.

In one possible embodiment, the first device DIS1 comprises a battery power source for which a charge level can be obtained. The server may poll it regularly in order to receive, or may receive spontaneously from the first device DIS1, information concerning the non-availability of the device when its battery level is lower than a minimum charge threshold. The server then issues a message of non-availability of the first device.

Shown in FIG. 3 are the steps of a method according to a possible embodiment of the invention. The method initially begins with a preliminary step 200 of the persistent storage (typically ROM) of user data on the communicating device DIS1.

Then, during a current step 300, the second device DIS2 requests the user data concerning the user of device DIS1 from the server SERV by sending message REQ-DAT to the server SERV. The message/query REQ-DAT may contain the respective identifiers of devices DIS1 and DIS2.

During step 302, the server SERV checks in an internal database containing the tree of relations of the social network users, to see if a segment exists between the users of the first and second communicating devices DIS1 and DIS2, for example by checking whether a segment exists between their respective nodes characterized by their identifiers ID1 and ID2 received in the query REQ-DAT.

If the outcome of the test of step 302 is negative (arrow N from the test), the users of the first and second devices have no relation in the social network. The server SERV then rejects in step 303 the request for the user data of the user of device DIS1, and sends for example an error message ERROR-MSG.

If the outcome of the test of step 302 is positive (Y arrow from the test), the users of the first and second devices are indeed in the server database as having a relation in the social network. The server SERV accepts the request from the second device DIS2. The server SERV looks up the address information of device DIS1 in its internal database, in this case to verify that it has an IP address corresponding to the identifier of the first communicating device DIS1.

When the server SERV has in its database a current address of the first device DIS1 on the network that connects (directly or indirectly) the first and second communicating devices DIS1 and DIS2, the server SERV can directly return (arrow 305) the address of the first device DIS1 in a message ENV-IP (step 308).

In step 304, the server SERV is also able to send a request to the first device DIS1 in a message REQ-IP in order to obtain the current IP address of the first device DIS1 on the network that connects the first and second communicating devices DIS1 and DIS2. This step can be performed repeatedly and regularly in order to keep current the address of the first device DIS1 stored in the database of the server SERV.

Then, in step 306, upon receiving message REQ-IP, the first device DIS1 returns its IP address in message RET-IP, which includes information about its current IP address for example. The server SERV is then able to transmit this IP address to the second device DIS2 (message ENV-IP).

Still in step 306, the server SERV verifies that an address of the first device DIS1 is in fact returned via message RET-IP. This verification allows determining for example whether the first device is connected and online and able to provide its current IP address, which can then be associated with said unique identifier.

Thus, the user data are no longer accessible when the communicating device is not connected and/or online, or when the user has deleted his or her data from the communicating device.

If the outcome of the verification in step 306 is negative (arrow N from step 306), the first device DIS1 has not returned an address in response to the request that was sent. This situation can arise when the first device is not accessible because it is switched off or it has no available network allowing it to send and receive such address requests for example. When appropriate, the server SERV can send a message indicating the absence (message ABS-MSG) of the first device DIS1 to the second device DIS2.

When the outcome of the verification in step 306 is positive (arrow 0 from step 306), the server SERV has obtained from the first device DIS1 at least one IP address of that device on the network connecting the devices DIS1 and DIS2, this address being stored internally in a database of the server SERV with the identifier of the first device DIS1 from the node graph of the social network.

Next, in step 308, the server SERV can send the retrieved address in message ENV-IP to the second device DIS2 so that the latter device can reach the first device DIS1 at its current address.

In step 310, the second device DIS2 requests the user data from the first device DIS1 on the network linking the first and second communicating devices, in a request REQ-DAT-IP to the address retrieved from the server.

Then, in step 312, the first communicating device DIS1 can respond to the direct request of the second communicating device DIS2, by sending it the data of the first user in a message RET-DAT-IP. The transmitted data may be at least a portion of the data previously stored in the first device DIS1 in step 200. Upon receipt of message RET-DAT-IP and of the data sent by device DIS1, the second device DIS2 can display the user data from the first device DIS1 on a social network web page. This web page can, for example, be displayed to the second user via a graphical interface of that user's device.

It is understood that FIG. 3 is only an example embodiment provided for illustrative purposes. Other variants can be envisaged. For example, in the case where the first device DIS1 has changed its address on the network connecting the two communicating devices DIS1 and DIS2, steps 304 to 308 can be performed again so that the second device DIS2 receives from the server SERV the new address of the first device DIS1 (in particular via a new message ENV-IP).

As another example, upon receipt by the first device DIS1 of a request received directly from the second device DIS2, the method may comprise a step of verifying with the server SERV that the request for user data received by the first device DIS1 does indeed comes from a device whose user has a segment in common with the user of the first device DIS1 in the social network.

In one possible embodiment, the user can define in advance on what medium his or her data is to be stored. Thus, the user can choose between storing his or her user data on the communicating device (such as a mobile phone), on another communicating device of the user (such as a digital tablet), or in a trusted remote storage space (such as a connected external hard drive or a server of a telecommunications carrier). For example, during the initiation step, the user can specify to the server SERV the IP address of the medium where he or she wants his or her user data to be stored. The medium chosen by the user for storing his or her data is specified to the server which remembers the medium (by IP address) for the identifier of the user where the user data are stored. Then the social network users are automatically routed by the server SERV to the address of the medium chosen for accessing said data.

The communicating devices may receive in advance a fixed IP address set by the server SERV and which will be stored:
in the memory of the device, and
in the internal database of the server in correspondence with the respective identifiers of devices in the social network tree.

Thus, the server determines a graph of nodes that allows redirecting communicating devices to fixed addresses for accessing the data of other users. One can see from the foregoing that the graph of nodes can provide information on the location of user data among one or more possible communicating devices.

Represented in FIG. 4 is an example sequence diagram of possible exchanges between elements DIS1, DIS2, and DIS3 at the end of the method steps represented in FIG. 3.

Consider a scenario in which a user of the second device DIS2 has recently established a relation in the social network with the user of the first device DIS1, and he wants to view the user data for that user for the first time.

According to one possible embodiment, the following steps can be implemented to do this:
200: The user of the first device DIS1 saves his user data beforehand in a means of persistent storage of his communicating device which was chosen for storing them locally;
300: The user of the second device DIS2 wishes to view the user data from the first device DIS1 and sends a request to that effect to the server SERV;
308: The server SERV notes that, according to its internal database, the users of the first and second devices have a common social segment in the social network and sends the current IP address of device DIS1 on the network linking the two devices DIS1 and DIS2; said address may possibly already be stored in the server database, or can be updated in steps 304 and 306 above;
310: The user retrieves via the server SERV the IP address allowing him to contact the first device DIS1 directly and request the desired user data;
312: The first device DIS1 receives the query and returns the user data requested by the second device DIS2.

For the server to maintain an updated database with, for each of the users of the social network, a current address for their communicating device, it can be arranged that steps 304 and 306 are carried out regularly in a polling type of method (regularly polling clients to determine system updates to be made).

When the server fails to obtain a response from the first device, the server can send an away message (in step 305) to the device requesting user data from the first device DIS1.

When the second device DIS2 has already obtained the address of the first device DIS1 from the server SERV, it is understood that the second device DIS2 can directly request the desired user data via a new request to the retrieved address (step 400). The up-to-date user data are then sent in response (step 312).

In FIG. 5, a communicating device DIS according to the invention is schematically illustrated. The device comprises at least:
storage means such as memory MEM which can be persistent and non-volatile (ROM memory, for example);
means for communicating an IP address at the request of a server, and possibly in the form of a wireless and/or wired communication interface COM comprising for example a telecommunications radio module, WiFi, Bluetooth, or other module;
a data processing means PROC such as a processor, for transmitting user data at the request of a communicating device made to the device address;
a graphical user interface GUI which allows:
   displaying at least one social network web page,
   viewing the data stored in the storage means of the device,
   accessing the data of social network users,
a security element ID of the communicating device which allows authenticating the device with a unique identifier, such as a SIM card or virtual SIM card,
a battery power source BAT.

In FIG. 6, a server SERV of the invention is schematically illustrated. The server comprises at least:
storage means including, for example:
   a first database DB1 for storing the tree graph of nodes of the social network with, corresponding to each node, an identifier of the devices linked to the social network, an IP address of these devices, and a unique identifier associated with each device;
   a second database DB2 for storing other data concerning the social network and user data from devices which the user did not want to store locally on his or her device;
means of communicating an IP address at the request of a communicating device, and which can be in the form of a wireless and/or wired communication interface COM comprising for example a telecommunications radio module, WiFi, Bluetooth, or other module;
data processing means PROC, in particular for:
   associating at least one identifier of a communicating device with an IP address;
   verifying that the mesh network comprises a relation between the nodes corresponding to the identifiers of the devices of the social network users;
   transmitting the IP address of the first device to the second device via the communication interface COM, to allow direct access to user data on the first device and using the IP address transmitted.

The server is also provided to verify the association between the user and the unique identifier of the devices, relative to a security element of the communicating device (a SIM card or virtual SIM card of the device for example).

Of course, the invention has been described with a few examples but it can be applied to other embodiments apparent to the skilled person. For example, the user data accessible by a communicating device can be video data obtained in real time from a camera of the accessed communicating device, for example in a stream of video data.

Additional functions relating to user data can be implemented, such as a function of secure storage space acting as a data safe.

1. A method for processing user data intended for display on a web page of a social network, wherein:
said user data are stored in a first communicating device and can be viewed remotely by at least a second connecting device,
the social network is organized in a mesh network having a plurality of nodes, and a server hosting the social network associates each node of the mesh network with a communicating device identifier, a first and a second identifier respectively associated with the first and second devices being stored on said server, and
the server stores, in addition to the identifier of the first device, an IP address of the first device on a communication network currently being used by the first device,
the method comprising, when the second device requests access to the user data (REQ DAT), at least the steps of:
verification by the server that the mesh network comprises a relation between the nodes respectively corresponding to the first and second identifiers;
and, when appropriate, transmission of the IP address of the first device to the second device by the server, to allow direct access to said user data on the first device and using the IP address transmitted.

2. The method according to claim 1, wherein the server also knows the first device by a unique identifier specific to the first device, a current IP address of the first device being associated with said unique identifier.

3. The method according to claim 2, wherein the server polls the first device in order to:
determine whether the first device is connected and online,
and, when appropriate, obtain a current IP address of the first device to be associated with said unique identifier.

4. The method according to claim 2, wherein the unique identifier specific to the first device is an identifier of a security element of the first communicating device, also intended to be used for authentication of said first device.

5. The method according to claim 2, further comprising a step of verifying the unique identifier of the first device when there is a request for access to the data stored on the first device.

6. The method according to claim 1, wherein the server polls the first device to determine whether the first device is connected and online, and publishes a message of non-availability of the first device, at least in the case of non-availability of data on the first device.

7. The method according to claim 1, wherein, the first device comprising a battery power source:
a charge level of the battery is obtained and compared with a threshold, and
if the level is below the threshold, the server receives information indicating non-availability of the first device and publishes a message of non-availability of the first device.

8. The method according to claim 1, wherein at least some of the user data are stored by the server so that, in case of non-availability of the first device, the data are accessible for viewing by the second device upon request.

9. The method according to claim 1, wherein at least some of the user data are only accessible from the first device and comprise personal data including at least:
bank account data,
and/or vital statistics,
and/or personal videos and/or audio data and/or images.

10. The method according to claim 1, wherein the server also knows the second device by means of a unique identifier specific to the second device, the request to access user data by the second device further comprising this identifier.

11. The method according to claim 10, wherein the unique identifier specific to the second device is an identifier of a security element of the second communicating device, also intended to be used for authentication of said second device.

12. A non-transitory computer program product comprising instructions for implementing the method according to claim 1 when said program is executed by a processor.

13. A communicating device, serving as the first device of the method according to claim 1, comprising at least means for storing user data, means for communicating an IP address at the request of a social network server, and means for transmitting user data to said IP address at the request of a second communicating device.

14. A social network server for implementing the method according to claim 1, comprising:
means for associating at least one identifier of a first communicating device with an IP address of the first device,
means for storing:
the first identifier and a second identifier respectively associated with the first device and a second device, and
an IP address of the first device on a communication network currently being used by the first device,
means for:
verification by the server that the mesh network comprises a relation between the nodes respectively corresponding to the first and second identifiers;
and, when appropriate, transmission of the IP address of the first device to the second device by the server, to allow direct access to said user data on the first device and using the IP address transmitted.
